(19) United States
(12) Patent Application Publication
(10) Pub. No.: US 2001/0014161 A1
(43) Pub. Date: Aug. 16, 2001

(54) Method for controlling a loudness level of an electroacoustic transducer

(76) Inventors: Stefan Baiker, Basel (CH); Rudolf Tschanz, Langendorf (CH)

Correspondence Address: BIRCH STEWART KOLASCH & BIRCH, PO BOX 747, FALLS CHURCH, VA, 22040-0747, US

(21) Appl. No.: 09/775,635

(22) Filed: Feb. 5, 2001

(30) Foreign Application Priority Data
Feb. 14, 2000 (EP) 00810124.8

(51) Int. Cl. H04R 29/00

(52) U.S. Cl. 381/59; 381/58; 381/111

(57) ABSTRACT

The loudness level of an electroacoustic transducer (6) of a device (1) is controlled such that a loss in the sound pressure caused by an acoustic leak is compensated as best as possible. The device (1) is, for example, a receiver of a telephone, a hand-held radio telephone, a cordless telephone or the like. A variable interspace (22) is formed between the receiver, or earpiece (3) thereof and the ear (16) of the user. The sound pressure in the interspace (22) is measured with the aid of an acoustic sensor (11). The power of the loudspeaker (6) is controlled as a function of the measured sound pressure with the aid of a control circuit (9). The acoustic sensor (11) is, for example, a microphone which is arranged in a separate spatial volume (14) next to the loudspeaker (6).

### TECHNICAL FIELD

The invention relates to a method for controlling a loudness level of an electroacoustic transducer of a device for transmitting acoustic signals to a sound pick-up located in the vicinity, a variable interspace being formed between the device and the sound pick-up. The invention also relates to an apparatus for carrying out the method.

### PRIOR ART

The practice of telephoning has long been conducted under the most varied environmental conditions. The background noises are appropriately varied. This is so, in particular, for cellular phones, which are used not only in more or less quiet rooms, but also on the street, on building sites etc. It is obvious that the intelligibility of the loudspeaker signal is reduced when there is a raised noise level. Correspondingly, the user must press the telephone more firmly to his ear. However, this can be unpleasant. Conversely, it may also be that the sound level of the electroacoustic transducer of the telephone receiver is perceived as too high, and so the receiver must be held at a certain distance from the ear.

EP 0 909 110 A2 discloses an earpiece (for a telephone or the like) in which it is ensured in an acoustic way that acoustic power is emitted as well as possible. For this purpose, the rear side of the loudspeaker (of which the front side emits the actual useful signal) is open toward a volume which, for its part, is likewise coupled directly via lateral channels and separate openings to the acoustic space formed between the ear and earpiece. The so-called “leak tolerance” is increased by the acoustic concept described. That is to say, despite the variable acoustic load, which constitutes the acoustic space, naturally always changing, between ear and earpiece, the largest possible portion is emitted outward to the ear from the earpiece. The so-called “acoustic leak” is therefore compensated up to a certain degree in the direct acoustic analog way.

In order to simplify the operation of cellular phones, it has already been proposed to switch over automatically between a receiver mode and a hands-free mode (EP 0 564 160 B1). For this purpose, a sensor is installed in the cellular phone in order to measure the distance from the head of the user. If a specific distance is exceeded, the electroacoustic transducer of the earpiece is operated in a hands-free mode. It has also been proposed in this context to set the loudness level of the earpiece as a function of the measured distance as long as the distance specified as limit is not exceeded.

However, the action of this known compensation is not capable of satisfactorily eliminating the problem named at the beginning.

### SUMMARY OF THE INVENTION

It is the object of the invention to specify a method and an apparatus of the type mentioned at the beginning which permit the acoustic signal emitted by the electroacoustic transducer to be set as the situation requires.

The object is achieved as defined by the features of claim 1. In accordance with the invention, a device which has an electroacoustic transducer for transmitting acoustic signals to a sound pick-up (human ear) located in the vicinity is equipped with, or coupled to, an acoustic sensor (for example, a dynamic microphone) which measures the sound pressure present in the acoustic interspace between the device and sound pick-up. The power of the electroacoustic transducer is controlled or regulated on the basis of this measurement.

Said sound pressure is, of course, a function of a plurality of parameters. It is important that not only the “acoustic leak”, but also the distance between the device and the user's ear are influential. This influence can, of course, be selectively reinforced by using a directional microphone which reacts particularly well to the acoustic power reflected by the ear. Overall, the advantage proves that the loudness level (or the spectral distribution of the signal power) of the loudspeaker can be controlled automatically within a relatively large power range.

The electroacoustic transducer and the acoustic sensor are preferably arranged in such a way that a feedback effect is produced which decreases as the acoustic space becomes less closed. The distance between the device and ear of the user need not always be decisive. A relative lateral displacement of ear and device can lead under some circumstances to a perceptible acoustic leak, and thus to a low level of intelligibility.

As already mentioned, it is also possible to use an acoustic sensor which reacts, in particular, to the variation in the distance between device and ear.

In one of a plurality of possible embodiments, the control circuit is designed such that losses in the sound pressure caused by an acoustic leak are compensated (as well as possible, as required). The aim in this case is to keep the subjective impression of the loudness level, and thus of the intelligibility of the speech signal, always approximately in the same range. Because the subjective impression of the loudness level depends not only on the physical total power of the acoustic signal, but also on the distribution of the energy within the signal spectrum, it can be sensible under specific circumstances selectively to control (or to amplify) the power for specific spectral components.

The control is preferably performed on the basis of frequencies in the lower part of the acoustically relevant frequency range. That is to say, a prescribed frequency range is extracted from the acoustic signal—either by the acoustic sensor itself or by a downstream filter circuit (for example in a DSP)—such that the power of the electroacoustic transducer is controlled on the basis of the power of the extracted frequency range.

To the extent that a selective feedback is desired at all, this can also, of course, be carried out with any desired filter (in order, for example, particularly to weight the frequency ranges relevant to intelligibility).

An interesting possible application for the invention emerges from the following considerations: it is necessary, on the one hand, for the loudspeaker of a telephone receiver, of a cellular phone etc. to be sufficiently loud to continue to ensure intelligibility even when the receiver is lying directly on the ear, while on the other hand it also may not be set too loud (in order not to exceed the pain barrier). The feedback according to the invention now renders it possible to solve this problem. The magnitude of the acoustic leak (which is expressed by the ratio between the emitted and measured acoustic signals) can be used for the purpose of establishing whether the earpiece is too far from the ear. In such a case, the electroacoustic transducer of the receiver can be switched over to a mode suitable for hands-free operation.

The electroacoustic transducer and the acoustic sensor are arranged directly next to one another, for example, in the device or in the earpiece thereof, but in acoustically separate spatial volumes. The two said spatial volumes are provided with openings which are arranged in surface regions (ear rest) of the housing bordering one another. The aim and benefit of this embodiment reside in a compact design. In accordance with a particularly preferred embodiment, the two spatial volumes are arranged in a quasi-interleaved fashion, the openings for the acoustic sensor being located more or less in the center of the region which is occupied by the openings provided for the acoustic transducer.

This does not, however, in any way exclude the two elements from also being provided, if required, at a distance from one another or even in separate housings.

It is typical to provide, in a housing region designed as earpiece, a plurality of openings for the exit of sound from the electroacoustic transducer, and at least one opening for the entry of sound to the acoustic sensor. Said housing region is generally relatively flat. The aim is for the smallest possible direct transfer of the sound emerging from the first-named openings to be possible to the second-named opening for the acoustic sensor. However, the sound is to be dammed or reflected, principally by the sound pick-up (user's ear) before it reaches the acoustic sensor (indirect coupling).

The acoustic sensor is formed, for example, by a microphone capsule which is arranged in a delimited spatial volume in such a way that an empty spatial volume is present between the opening through which the sound to be detected enters and the capsule. The design of this spatial volume is a function, of course, of the technical requirements of the microphone capsule.

An important field of application of the invention is the sector of telephone sets and radio sets. Consideration is given firstly to hand-held radio telephones (cellular phones, cordless telephones) having the additional possibility of hands-free operation. However, there are also other devices which can require control of loudness level (or a selective spectral power control) as a function of the distance of the ear. Mention may be made, for example, of intercom systems. In the case of the latter, it frequently happens that the user either approaches too little and understands virtually nothing because of the unexpectedly low loudness level, or that he approaches too near and his hearing is then impaired because of the excessively high loudness level.

If the user takes the device close to his ear, not only is the acoustic leak small, but at the same time the transmitter microphone is also in a position favourable for reception near the user's mouth. The invention now further proposes varying or setting the sensitivity of the transmitter microphone of the device (mouthpiece) on the basis of the measured acoustic leak (for example the smaller the acoustic leak the lower the sensitivity of the transmitter microphone).

Further advantageous embodiments and combinations of features of the invention emerge from the following detailed description and the totality of the patent claims.

### BRIEF DESCRIPTION OF THE DRAWINGS

In the drawing used to explain the exemplary embodiment:

FIG. 1 shows a schematic of a receiver having a control circuit for controlling the loudspeaker.

### WAYS OF IMPLEMENTING THE INVENTION

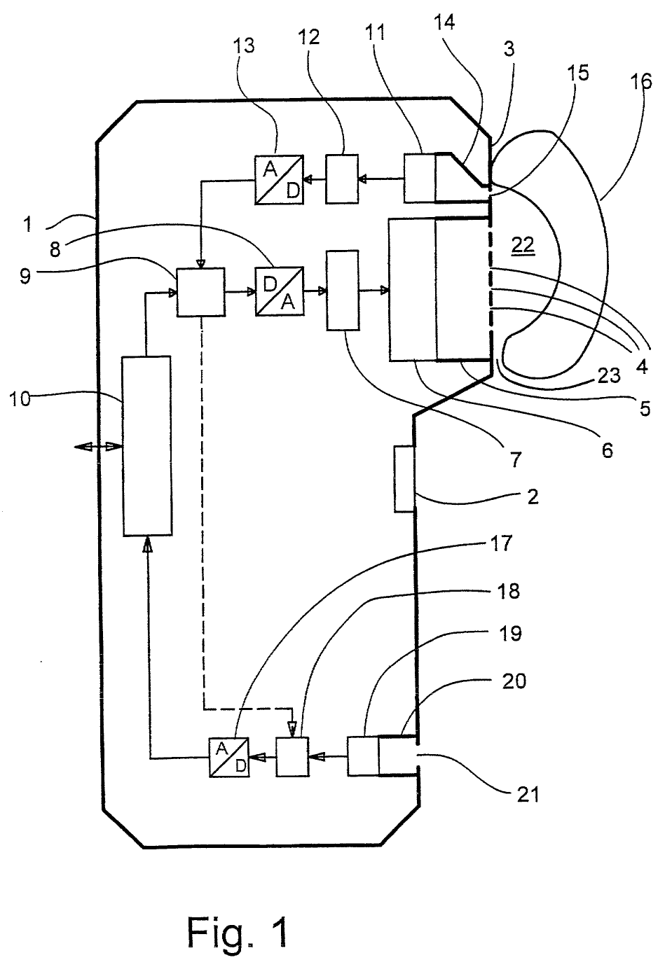

A handset 1 of a telephone is shown in outline in FIG. 1. Said handset can be equipped with operating elements, for example with an optical display 2, a keypad (not illustrated), or the like (as is usual, for example, for cellular phones or cordless telephones). A multiplicity of openings 4 are provided in a region of the housing which is designed as earpiece 3. The openings 4 constitute the acoustic output of a spatial volume 5 in which a loudspeaker 6 (electroacoustic transducer) is installed. The loudspeaker 6 is driven in a way known per se by an amplifier 7. Analog speech signals which have been transmitted digitally by another telephone set to the telephone circuit 10 of the handset 1 are applied to the amplifier 7.

The handset 1 also has a microphone 19 in the region of the mouthpiece (which is arranged at the lower end of the front side of the handset 1). The microphone 19 picks up sound which is to be transmitted by the device and which enters through an opening 21 in the housing and a spatial volume 20 arranged behind the opening 21. An amplifier 18 conditions the signal in a way known per se such that it is digitized by an A/D converter 17 and can be output to the telephone circuit 10 (for transmission to a device (not illustrated) of the call party).

In the scope of the invention, the digital signals at the output of the telephone circuit 10 are firstly processed by a digital signal processor 9 (DSP) before they are output to the amplifier 7 via the D/A converter 8. The DSP 9 has an additional input for the signals picked up by a microphone 11, conditioned by an amplifier 12 and digitized by an A/D converter 13.

The microphone 11 is located at the rear end of a spatial volume 14. At the front end, said spatial volume 14 has an opening 15 which is placed next to the openings 4 in the earpiece 3. The two spatial volumes 5 and 14 are separated and acoustically decoupled by partitions.

The following cycle occurs when the handset 1 is being used: the acoustic signals of the loudspeaker 6 are emitted to the user's ear 16 through the openings 4. A specific sound level builds up in the interspace 22 which is formed between the earpiece 3 and the ear 16. This sound level depends on the extent to which said interspace 22 is sealed because of the contact between the ear 16 and the earpiece 3. The acoustic leak is relatively small in the case of close contact. The sound pressure measured by the microphone 11 is correspondingly relatively high. The electric signal of the microphone 11 is amplified by the amplifier 12 to the required extent and output to the DSP 9 via the A/D converter 13. If, by contrast, a gap 23 (acoustic leak) is present at a point between the ear 16 and earpiece 3 (ear rest), a lower sound pressure builds up in the interspace 22. As a result, the measuring signal will be smaller in relation to the emitted acoustic power of the loudspeaker 6.

The DSP 9 uses the measuring signal supplied by the microphone 11 for the purpose of optimally setting the power of the amplifier 7, and thus of the loudspeaker 6. The larger the ratio of “measuring signal to emitted signal”, the lower the loudness level set. Conversely, if the strength of the measuring signal is low by comparison with the signal to be emitted, the power of the amplifier 7 is turned up so that the user can understand the call party despite the high acoustic leak.

There are various possibilities of using the measured signal for control. For example, it is possible simply to determine the total power. However, it is also possible to use a filter to extract a specific spectral region and to use the power in this region as control variable. The lower half of the spectral region of the signal, for example, can be extracted for this purpose. Specifically, the upper frequencies are often transmitted relatively well in any case, and are therefore not critical.

The type of filtering can also depend on the type of loudspeaker capsule. The effect of the acoustic leak, specifically that lower frequencies appear weaker, is plainer in the case of piezoelectric loudspeaker capsules than with magnetic capsules.

A PID controller, for example, can be implemented in the DSP 9. However, it is also possible to use predictive controllers. It is also conceivable to store a table from which a predetermined output value for the gain is yielded for each value of the measuring signal. A stepped switching curve can also be realized. That is to say, there is switching to and fro between two, three or more discrete desired values.

It is recommended to take account of the useful signal output by the telephone circuit 10 when controlling the loudness level of the loudspeaker 6. In the event of a low acoustic leak, the signal picked up by the microphone 11 will correspond to the “desired signal” supplied by the telephone circuit 10 except for a few distortions (which are caused by the acoustic transmission between loudspeaker 6 and microphone 11). The DSP 9 will ensure in this case that the low acoustic leak is compensated.

Compensation is entirely possible for small distances of, for example, less than 1 cm. In the case of a few centimeters, the acoustic leak will already quickly be quite large. If the receiver is removed entirely from the ear, the sound pressure collapses, and this is established thanks to the feedback to the DSP 9 via the microphone 11, amplifier 12 and A/D converter 13. The DSP 9 can switch over to hands-free operation in this situation. In this context, the signal from the microphone 19 of the mouthpiece can also, if required, be amplified more than usual, in order to compensate the probably larger distance between the mouthpiece of the handset 1 and user's head. The amplifier 18 can be controlled from the DSP 9.

It follows from what has been said above that the acoustic leak can be established in principle only when the loudspeaker is emitting an acoustic signal. If measurements are to be carried out in longer pauses, test signals can also be generated from time to time and output by the loudspeaker. However, such test signals can be perceived as disturbing by the user.

The last-used gain can be maintained in shorter signal pauses. In the case of longer pauses, it can be sensible to convert the gain into a specific value.

Of course, the invention is not limited to the exemplary embodiment illustrated. In particular, control can also be implemented with the aid of analog electronic components, and thus of analog signals. It is also possible to combine the electronic compensation according to the invention with the acoustic feedback of the amplifier known from the prior art. The acoustic feedback then ensures optimum efficiency of the emission toward the ear. The acoustic sensor permits improvement, particularly in the case of an increased acoustic leak.

Certainly, the spatial volume 14 is illustrated in FIG. 1 as separate from the spatial volume 5. However, it is also possible to arrange the spatial volume 14 and the acoustic sensor inside (for example in the center of) the spatial volume 5. Furthermore, it would be possible to connect downstream of one of the openings 4 a type of “measuring channel” which guides the sound pressure out of the region of the spatial volume 5 toward the microphone 11.

If the DSP 9 establishes that the acoustic leak is too large for it to be possible to operate the device sensibly in the normal receiver mode, it switches over to a high power so that it is possible to telephone in the hands-free mode. It is even conceivable to provide automatic switchover to an external loudspeaker. For this purpose, the DSP 9 could further have an output to the telephone circuit 10. If the DSP 9 establishes that the acoustic leak is too large, it signals this to the telephone circuit 10 which, for its part, then transmits the speech signal no longer (or no longer only) to the loudspeaker 6, but (additionally) to a more powerful loudspeaker (not illustrated) (which can, for example, be integrated in the assigned desk station or else directly in the handset, or which can also be formed by the vehicle loudspeaker connected via cables).

In the case of a hard-wired handset; the telephone circuit will be built into the desk station in the normal case. On the other hand, additional HF circuits are provided for receiving the radio signals in the case of a cellular phone. However, the invention can also be used with headphones or the like in order to be able to set the loudness level and/or signal spectrum correctly and automatically even when the headphone is not optimally placed.

It may be stated in summary that the invention has created the possibility of correctly setting the loudness level (or the spectrum) of the earpiece as a function of the respective conditions.

1. Method for controlling an electroacoustic transducer (6) of a device (1) for transmitting acoustic signals to a sound pick-up (16) located in the vicinity, a variable interspace (22) being formed between the device (1) and the sound pick-up (16), characterized in that a sound pressure in the interspace (22) is measured with the aid of an acoustic sensor (11), and characterized in that a power of the electroacoustic transducer (6) is controlled as a function thereof.

2. Method according to claim 1, characterized in that the power of the electroacoustic transducer (6) is controlled so as to compensate a loss in the sound pressure caused by an acoustic leak.

3. Method according to claims 1 and 2, characterized in that only a portion, in particular a lower portion, of a frequency range of the sound pressure is used for control.

4. Method according to claim 1, characterized in that the electroacoustic transducer (6) is switched over to a hand-free mode when the measured sound pressure falls below a specific value.

5. Device having an electroacoustic transducer (6) for transmitting acoustic signals to a sound pick-up (16) located in the vicinity, a variable interspace (22) being formed between the device (1) and the sound pick-up (16), characterized in that an acoustic sensor (11) is provided for measuring a sound pressure in the interspace (22), and a control circuit is provided for controlling a power of the electroacoustic transducer (6) as a function of the measured sound pressure.

6. Device according to claim 5, characterized in that the electroacoustic transducer (6) and the acoustic sensor (11) are arranged and aligned in such a way that a feedback effect is produced which decreases with increasing acoustic leakage.

7. Device according to claim 5, characterized in that the control circuit is designed such that a loss in the sound pressure caused by an acoustic leak is compensated by an increase in the power of the electroacoustic transducer (16).

8. Device according to claim 5, characterized in that the control circuit is designed such that only a portion, in particular a lower portion, of a spectral region of the sound pressure is used for control.

9. Device according to claim 5, characterized in that the control circuit is designed such that the electroacoustic transducer (6) is switched over to a powerful hands-free mode when the ratio between the measuring signal and emitted signal exceeds a specific value.

10. Device according to claim 5, characterized in that the electroacoustic transducer (6) and the acoustic sensor (11) are arranged next to one another, but in acoustically separate spatial volumes (5, 14).

11. Device according to claim 5, characterized in that a plurality of openings (4) for the electroacoustic transducer (6), and at least one opening (15) for the acoustic sensor (11) are provided in a housing region designed as an earpiece.

12. Device according to claim 11, characterized in that the acoustic sensor (11) is arranged in its spatial volume (14) in such a way that an empty volume is formed between the acoustic sensor and the at least one opening (15).

13. Device according to claim 5, characterized in that it is designed as a telephone set.

14. Device according to one of claims 5 to 13, characterized in that it has a transmitter microphone (19) and a control circuit in order to set a gain or sensitivity of the transmitter microphone as a function of the measured sound pressure.
